(19) United States
(12) Patent Application Publication
(10) Pub. No.: US 2014/0000920 A1
(43) Pub. Date: Jan. 2, 2014

(54) SLIDE HAMMER DEVICE AND METHODS OF USING SAME

(71) Applicant: ALAN RICHTER, Perth (AU)

(72) Inventor: ALAN RICHTER, Perth (AU)

(73) Assignee: Longyear TM, Inc., South Jordan, UT (US)

(21) Appl. No.: 13/536,299

(22) Filed: Jun. 28, 2012

(51) Int. Cl. B25D 1/16

(52) U.S. Cl. 173/1; 81/27

(57) ABSTRACT

A slide hammer device having a guide sleeve, a selectively moveable elongate rod received within the guide sleeve, and a hammer assembly coupled to the elongate rod. The hammer assembly is shaped to accomplish removal of an inner tube from within a pipe element. The guide sleeve has a protective flange that protects a user's hand during advancement of the slide hammer device toward an opening of the pipe element.

### FIELD

This application relates generally to drilling equipment and methods and, more particularly, to devices and methods for removing an inner tube from a drill rod.

### BACKGROUND

In conventional drilling operations, inner tube assemblies and other core samplers are positioned within drill rods for purposes of obtaining core samples. After a core sample is maintained, the drill rod and inner tube assembly containing the sample may be retrieved to permit removal of the sample. Typically, the inner tube is shorter than the drill rod. Consequently, it is often difficult to access the inner tube, and force must be applied to the inner tube until the inner tube projects from an opening of the drill rod. In situations when the inner tube becomes stuck within a drill rod, even more force must be applied to accomplish removal of the inner tube.

Conventionally, removal of an inner tube assembly from a drill rod is accomplished using a hammer or mallet. Typically, a worker must swing the hammer or mallet through a first opening of the drill rod to make repeated contact with the inner tube assembly until the inner tube projects from an opposite opening of the drill rod. Usage of a conventional hammer or mallet in this manner can require significant expenditure of effort and time. Moreover, the conventional hammers and mallets that are typically used do not provide protection for the hands of workers, and injuries frequently result from these inner tube removal processes. Further, the brute application of force through the use of a hammer or mallet can damage the inner tube and/or the sample itself.

Accordingly, there is a need in the pertinent art for devices and methods for removing an inner tube assembly from a drill rod or other pipe element that provide protection for the hands of workers, increase efficiency in the removal of the inner tube assemblies, and minimize damage to the inner tube assembly and any samples contained within the inner tube assembly.

### SUMMARY

Described herein is a slide hammer device including a guide sleeve, a handle, an elongate rod slidably received within the handle, and a hammer assembly. The guide sleeve can include a protective flange for protecting the hand of a user of the slide hammer device. The guide sleeve is configured for operative engagement with the handle. The hammer assembly can include an impact head, an impact flange, and an elongate portion. The impact flange can be secured to the elongate portion, and the impact head can be secured to the impact flange. The elongate portion of the hammer assembly is engaged with the elongate rod such that both are configured for selective movement along the longitudinal axis of the slide hammer device. The guide sleeve defines a seat for the elongate portion of the hammer assembly. The elongate rod, which is engaged with the elongate portion of the hammer assembly, is moveable between an extended position and a retracted position. In the extended position, the proximal end of the elongate rod engages a proximal end of the guide sleeve. In the retracted position, the elongate portion of the hammer assembly engages the seat of the guide sleeve such that application of force to the handle transmits a corresponding axial force to the guide sleeve and the elongate portion of the hammer assembly.

Methods of using the slide hammer device to remove an inner tube from within a pipe element are also disclosed. In one aspect, the method can include advancing a slide hammer device into a first opening of a pipe element such that at least a portion of the impact head of the hammer assembly is received within the inner tube and the impact flange of the hammer assembly abuts the inner tube. The method can further include advancing the guide sleeve of the slide hammer device toward the hammer assembly such that the elongate rod of the slide hammer device is positioned in the retracted position, with the proximal end of the elongate portion of the hammer assembly engaging the seat of the guide sleeve. The method can still further include advancing the slide hammer device such that at least a portion of the inner tube projects from an opposed second opening of the pipe element.

### BRIEF DESCRIPTION OF THE DRAWINGS

These and other features of the preferred embodiments of the invention will become more apparent in the detailed description in which reference is made to the appended drawings wherein:

FIGS. 1A and 1B are partial cross-sectional views of an exemplary slide hammer device as described herein in a retracted position.

FIG. 2A depicts an isolated perspective view of a guide sleeve of an exemplary slide hammer device as described herein. FIG. 2B is a cross-sectional view of a guide sleeve of an exemplary slide hammer device as described herein.

FIG. 3A is an isolated perspective view of a handle of an exemplary slide hammer device as described herein. FIG. 3B is a cross-sectional view of a handle of an exemplary slide hammer device as described herein.

FIG. 4 is an isolated perspective view of a hammer assembly of an exemplary slide hammer device as described herein.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “an inner tube” can include two or more such inner tubes unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

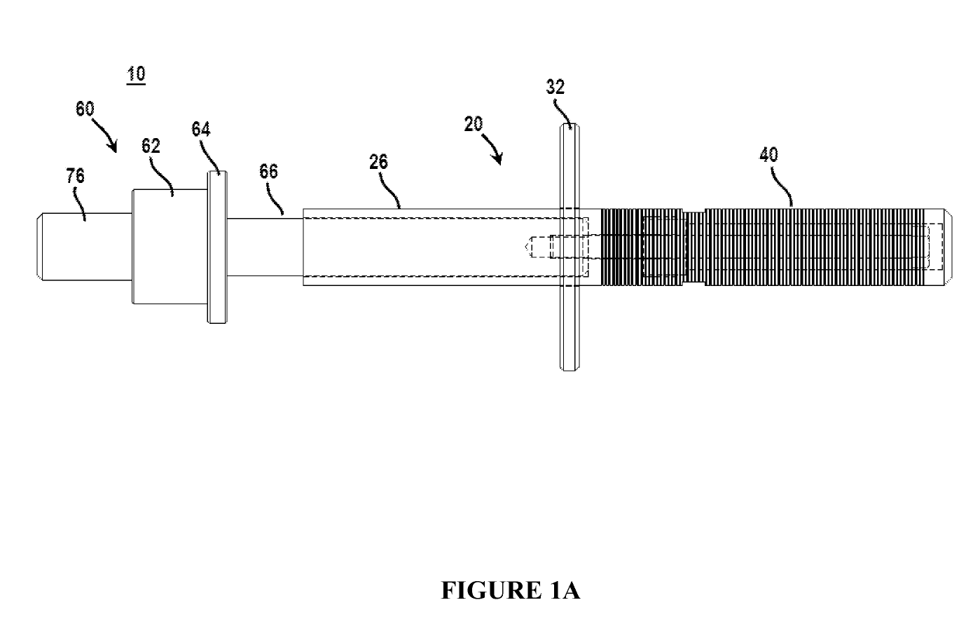

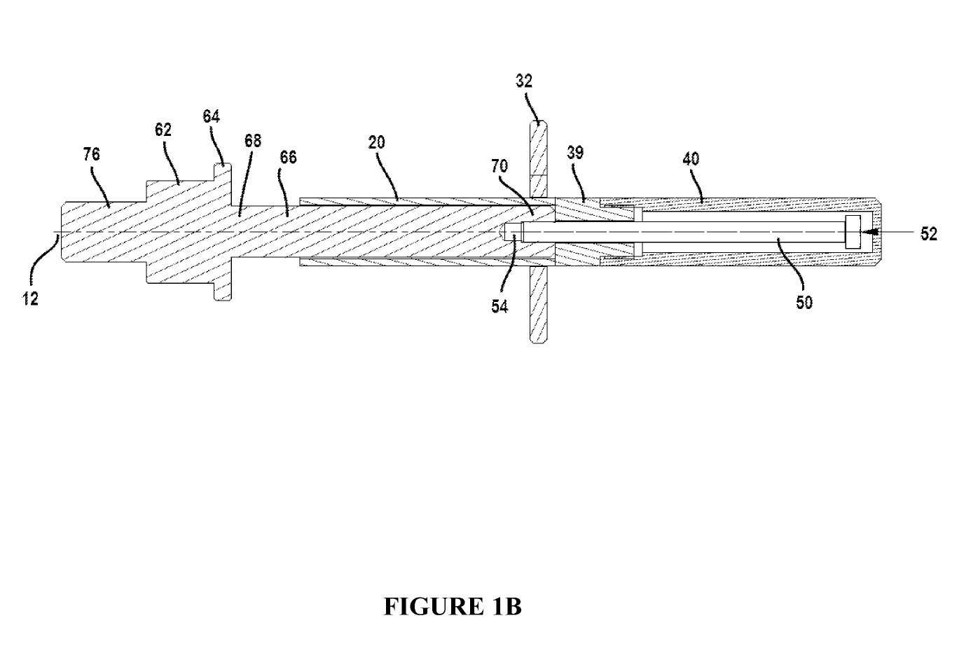

Described herein with reference to FIGS. 1-4 is a slide hammer device 10. As shown in FIG. 1B, the slide hammer device 10 has a longitudinal axis 12.

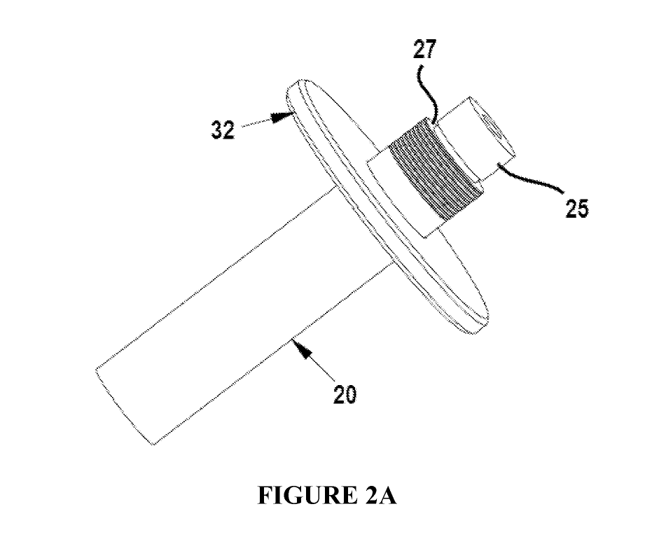

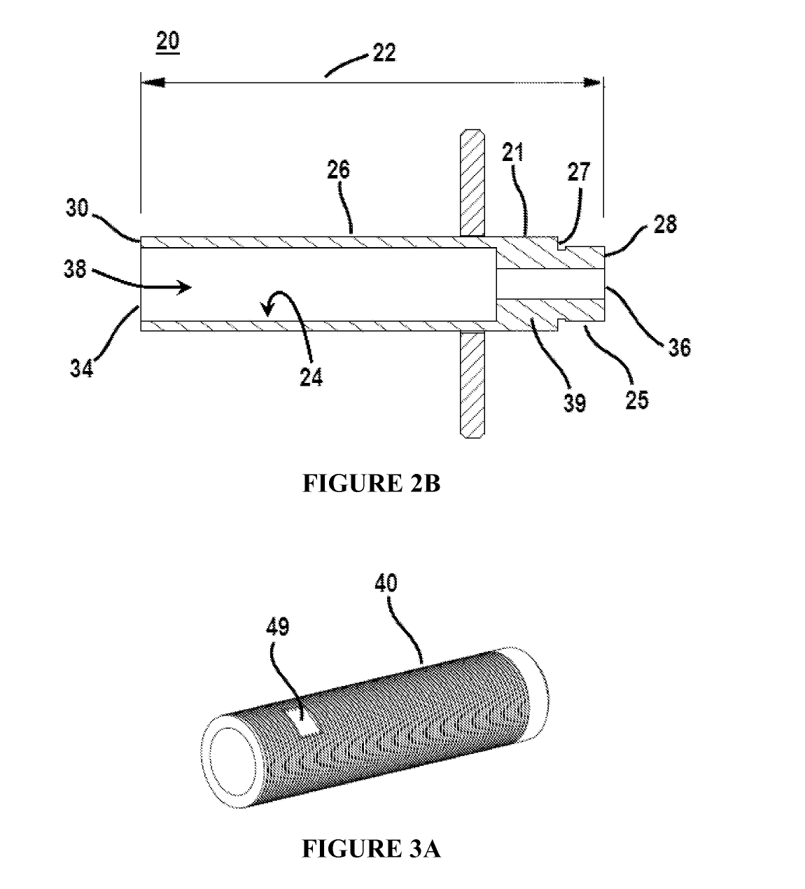

In one aspect, and with reference to FIGS. 1-2B, the slide hammer device 10 can comprise a guide sleeve 20. In this aspect, the guide sleeve 20 can have a longitudinal length 22, an inner surface 24, an outer surface 26, a proximal end 28, a distal end 30, and a protective flange 32. It is contemplated that the protective flange 32 can extend radially outwardly from the outer surface 26 of the guide sleeve 20. It is further contemplated that the protective flange 32 can be positioned between the proximal end 28 and the distal end 30 of the guide sleeve 20 as desired relative to the longitudinal axis 12 of the slide hammer device 10. As exemplarily shown, in another aspect, the protective flange 32 can be positioned substantially transverse to the longitudinal axis 12 of the slide hammer device 10. Optionally, the protective flange 32 can have a cross-sectional diameter. In exemplary aspects, the cross-sectional diameter of the protective flange 32 can range from about 100 mm to about 150 mm. Optionally, in another aspect, it is contemplated that the protective flange 32 can be integrally formed with the guide sleeve 20 by welding or other means.

Optionally, in exemplary aspects, it is contemplated that the protective flange 32 can be selectively moveable relative to longitudinal axis 12 of the slide hammer device 10. In these aspects, it is contemplated that the protective flange 32 can be detachably secured to a first location on the outer surface 26 of the guide sleeve 20 along the longitudinal axis 12 of the slide hammer device 10 such that, following detachment of the protective flange from the guide sleeve, the protective flange can be selectively moved to a second location on the outer surface of the guide sleeve along the longitudinal axis of the slide hammer device. It is further contemplated that the protective flange 32 can be secured to the outer surface 26 of the guide sleeve 20 using any conventional means, including, for example and without limitation, an adjustable tightening belt, a releasable lock, a slidable coupling, a slideable mount, and the like.

In another aspect and referring to FIGS. 2A and 2B, the distal end 30 of the guide sleeve 20 can define a distal opening 34, while the proximal end 32 can define a proximal opening 36. In this aspect, it is contemplated that the proximal and distal openings 32, 34 of the guide sleeve 20 can each have a respective diameter. In a further aspect, the inner surface 24 of the guide sleeve 20 can define a cavity 38 extending between the distal opening 34 and the proximal opening 32 (along the entire longitudinal length 22 of the guide sleeve).

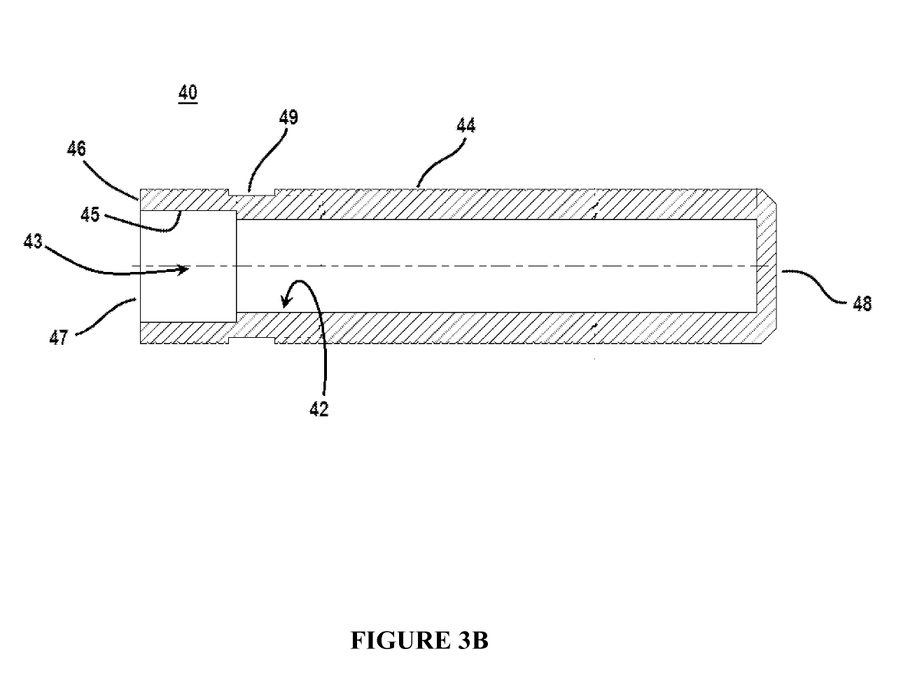

In an additional aspect, and with reference to FIGS. 1A-1B and 3A-3B, the slide hammer device 10 can comprise a handle 40 having an inner surface 42, an outer surface 44, a distal end 46, and a closed proximal end 48. In this aspect, it is contemplated that the distal end 46 can define a distal opening 47, while the inner surface 42 can define a cavity 43 extend from the distal opening along at least a portion of a longitudinal length of the handle 40 toward the closed proximal end 48. In exemplary aspects, the cavity 43 can extend substantially between the distal opening 47 and the closed proximal end 48. Optionally, in one exemplary aspect, the distal end 46 of the handle 40 can be configured for operative engagement with the proximal end 28 of the guide sleeve 20. In this aspect, it is contemplated that the distal end 46 of the handle 40 can be detachably engaged with the proximal end 28 of the guide sleeve 20. However, in other exemplary aspects, it is contemplated that the handle 40 can optionally be integrally formed with the guide sleeve 20.

In another exemplary aspect, and with reference to FIGS. 1-3B, the outer surface 26 of the guide sleeve 20 can comprise a radially recessed portion 25 positioned proximate the proximal end 28 of the guide sleeve. In this aspect, the radially recessed portion 25 can optionally substantially terminate into the proximal end 28 of the guide sleeve 20. Also, in this aspect, at least a portion of the radially recessed portion 25 can be threaded. It is contemplated that the radially recessed portion 25 can be radially recessed relative to an adjoining portion 21 of the guide sleeve 20. In an exemplary aspect, it is further contemplated that the inner surface 42 of the handle 40 can comprise a threaded portion 45 that is positioned proximate the distal end 46 of the handle and configured for threaded engagement with the radially recessed portion 25 of the outer surface 26 of the guide sleeve 20. In this aspect, it is contemplated that the threaded portion 45 can optionally substantially terminate into the distal end 46 of the handle 40. It is still further contemplated that the threaded portion 45 of the inner surface 42 of the handle 40 can be radially recessed relative to adjoining portions of the inner surface of the handle. It is still further contemplated that, upon threaded engagement between the radially recessed portion 25 of the outer surface 26 of the guide sleeve 20 and the threaded portion 45 of the inner surface 42 of the handle 40, the outer surface 26 of the adjoining portion 21 of the guide sleeve can be substantially flush with the outer surface 44 of the handle. Optionally, as shown in FIG. 2B, it is still further contemplated that the adjoining portion 21 of the guide sleeve 20 can define a shoulder surface 27 configured for engagement with the distal end 46 of the handle 40.

In exemplary aspects, it is contemplated that the outer surface 44 of the handle 40 can comprise one or more slots 49. In these aspects, it is further contemplated that the one or more slots 49 can comprise a plurality of slots that are circumferentially spaced about the outer surface 44 of the handle 40. It is still further contemplated that the one or more slots 49 can be positioned between threaded portion 45 of the inner surface 42 and the closed proximal end 48 of the handle 40 along the longitudinal axis 12 of the slide hammer device 10. Optionally, the one or more slots 49 can positioned proximate to and/or at least partially overlapping with the threaded portion 45 of the inner surface 42.

In other exemplary aspects, it is contemplated that the handle 40 can have a longitudinal length ranging from about 100 mm to about 200 mm and, more preferably, ranging from about 150 mm to about 180 mm, including, for example, an exemplary longitudinal length of about 165 mm. In still other exemplary aspects, it is contemplated that the threaded portion 45 of the inner surface 42 of the handle 40 can have a longitudinal length ranging from about 10 mm to about 50 mm and, more preferably, ranging from about 15 mm to about 40 mm, including, for example, an exemplary longitudinal length of about 25 mm.

In other exemplary aspects, it is contemplated that the outer surface 44 of the handle 40 can be configured to conform to the shape of a user's hand. For example, it is contemplated that the proximal end 48 of the handle can be tapered and/or curved to conform to the shape of a user's hand. In further aspects, it is contemplated that at least a portion of the outer surface 44 can define a conventional grip surface that is configured to improve a user's grip of the handle 40. In these aspects, it is contemplated that the grip surface can be defined thereon the outer surface 44 or be a distinct component that is separately applied to the outer surface. It is further contemplated that at least a portion of the outer surface of the adjoining portion 21 of the guide sleeve 20 can comprise a grip surface, thereby defining a substantially continuous grip surface between the handle 40 and the guide sleeve 20.

In an additional aspect, the protective flange 32 of the guide sleeve 20 can be positioned at a selected position along the longitudinal length 22 of the guide sleeve. In this aspect, it is contemplated that the proximal end 48 of the handle 40 can be spaced from the selected position by a first distance along the longitudinal axis 12 of the slide hammer device 10, and the distal end 30 of the guide sleeve can be spaced from the selected position by a second distance along the longitudinal axis of the slide hammer device. It is further contemplated that, in optional, exemplary aspects, the first distance can be greater than the second distance. However, it is contemplated that configurations of the guide sleeve 20 in which the first distance is substantially equal to the second distance or in which the first distance is less than the second distance can also be employed.

In a further aspect, the slide hammer device 10 can comprise an elongate rod 50 having a proximal end 52 and a distal end 54. In this aspect, it is contemplated that at least a portion of the elongate rod 50 can be slidably received within the cavity 43 of the handle 40. It is further contemplated that the proximal and distal ends 52, 54 of the elongate rod 50 can each have a respective cross-sectional diameter. In exemplary aspects, the cross-sectional diameters of the proximal and distal ends 52, 54 of the elongate rod 50 can be less than about 25 mm. It is still further contemplated that the cross-sectional diameter of the proximal end 52 of the elongate rod 50 can be greater than the diameter of the proximal opening 36 of the guide sleeve 20. In another aspect, the elongate rod 50 can be selectively moveable along the longitudinal axis 12 of the slide hammer device 10. In this aspect, it is contemplated that the elongate rod 50 can be selectively moveable along the longitudinal axis 12 of the slide hammer device 10 between an extended position and a retracted position. In an exemplary aspect, the extended position of the elongate rod 50 can correspond to a position in which the proximal end 52 of the elongate rod is configured to engage the proximal end 28 of the guide sleeve 20. In this aspect, it is contemplated that, by advancing the elongate rod 50 along the longitudinal axis 12 of the slide hammer device 10 until the proximal end 52 of the elongate rod engages the proximal end 28 of the guide sleeve 20, an impact force can be transmitted to the guide sleeve.

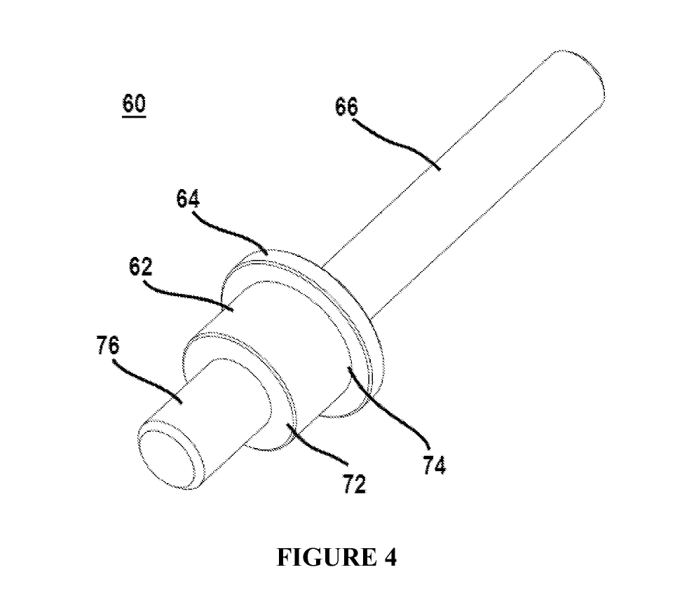

In yet another aspect, and with reference to FIGS. 1 and 4, the slide hammer device 10 can comprise a hammer assembly 60 comprising an impact head 62, an impact flange 64, and an elongate portion 66. In this aspect, the impact head 62 and the impact flange 64 can optionally have respective cross-sectional diameters. It is contemplated that the cross-sectional diameter of the impact head 62 can range from about 40 mm to about 80 mm, while the cross-sectional diameter of the impact flange 64 can range from about 60 mm to about 100 mm. It is further contemplated that the cross-sectional diameter of the protective flange 32 of the guide sleeve 20 can be greater than the cross-sectional diameter of the impact flange 64.

In an additional aspect, the elongate portion 66 can have a distal end 68 and a proximal end 70. In this aspect, the proximal end 70 of the elongate portion 66 can be securely engaged with the distal end 54 of the elongate rod 50 such that movement of the elongate rod along the longitudinal axis 12 of the slide hammer device 10. It is contemplated that the elongate rod 50 and elongate portion 66 can be configured for coupled sliding movement within the cavity 38 of the guide sleeve 20. It is further contemplated that the proximal end 70 of the elongate portion 66 can be securely engaged with the elongate rod 50 such that movement of the elongate rod along the longitudinal axis 12 of the slide hammer device 10 effects a corresponding movement of the hammer assembly 60 along the longitudinal axis of the slide hammer device. It is contemplated that the engagement between the distal end 54 of the elongate rod 50 and the proximal end 70 of the elongate portion 66 can be by any conventional means, including, for example and without limitation, threaded engagement, frictional engagement (such as a jam fit), and the like. In exemplary aspects, the distal end 54 of the elongate rod 50 can comprise one or more surface features to promote the engagement with the elongate portion 66. Alternatively, in other exemplary aspects, it is contemplated that the elongate rod 50 and the elongate portion 66 of the hammer assembly can cooperate to define an integral elongate element that possesses substantially the same functionality and attributes of the two elements together.

Optionally, in an alternative aspect, it is contemplated that the elongate rod 50 can be integrally formed with at least the elongate portion 66 of the hammer assembly 60.

In an additional aspect, the impact head 62 can have a distal end 72 and a proximal end 74. In a further aspect, it is contemplated that the impact flange 64 can be secured to and positioned between the distal end 54 of the elongate portion 66 and the proximal end 74 of the impact head 62. Optionally, it is contemplated that the impact head 62 can be integrally formed with the impact flange

Optionally, the hammer assembly 60 can comprise a head extension 76 secured to the distal end 72 of the impact head 62. In this aspect, the head extension 76 can extend from the distal end 72 of the impact head 62 along the longitudinal axis 12 of the slide hammer device 10. Optionally, the head extension 76 can have a cross-sectional diameter. It is contemplated that the cross-sectional diameter of the head extension 76 can range from about 20 mm to about 60 mm. In exemplary aspects, it is contemplated that the cross-sectional diameter of the impact head 62 can be greater than the cross-sectional diameter of the head extension 76. Thus, in these aspects, the head extension 76 can be configured for receipt within core barrels and other pipe-like elements that are too small to receive the impact head 62.

In exemplary aspects, the hammer assembly 60 can have a total longitudinal length ranging from about 250 mm to about 350 mm and, more preferably, ranging from about 280 mm to about 320 mm, including an exemplary longitudinal length of 290 mm. In additional exemplary aspects, it is contemplated that the head extension 76 can have a longitudinal length of about 50 mm, the impact head 62 can have a longitudinal length of about 40 mm, the impact flange 64 can have a longitudinal length of about 10 mm, and the elongate portion 66 can have a longitudinal length of about 190 mm.

In additional exemplary aspects, the inner surface 24 of the guide sleeve 20 can define a seat 39 for the proximal end 70 of the elongate portion 66 of the hammer assembly 60. In these aspects, it is contemplated that the seat 39 can correspond to a portion of the inner surface 24 of the guide sleeve 20 that projects farther inwardly than adjoining portions of the guide sleeve, thereby decreasing the diameter of the cavity 38 such that the elongate portion 66 of the hammer assembly 60 cannot pass through the cavity without engaging the seat. It is further contemplated that the proximal end 70 of the elongate portion 66 of the hammer assembly 60 can be configured to engage the seat 39 of the guide sleeve 20 such that application of force to the handle 40 along the longitudinal axis 12 of the slide hammer device 10 transmits a corresponding axial force to the guide sleeve and the elongate portion of the hammer assembly.

In additional exemplary aspects, it is contemplated that the slide hammer device 10 can be configured to provide an axial stroke ranging from about 100 mm to about 150 mm. In a particular exemplary aspect, the space between the distal end 30 of the guide sleeve 20 and the impact flange 64 can be about 40 mm when the elongate rod 50 is positioned in the retracted position, and the space between the distal end of the guide sleeve and the impact flange can be about 164 mm when the elongate rod is positioned in the extended position. Thus, in this aspect, it is contemplated that the axial stroke can be about 124 mm, which corresponds to the length of the portion of the elongate rod that can be advanced longitudinally before engaging the proximal end 32 of the guide sleeve. As demonstrated by this example, it is contemplated that the distal end 30 of the guide sleeve 20 can remain axially spaced from the impact flange 64 in both the extended and retracted positions. Similarly, it is contemplated that the proximal end 52 of the elongate rod can remain axially spaced from the proximal end 48 of the handle in both the extended and retracted positions.

In use, the disclosed slide hammer device 10 can be employed in a method of removing an inner tube from within a pipe element. The pipe element can have a longitudinal axis, and the inner tube can be configured for movement within the pipe element along the longitudinal axis of the pipe element. In exemplary uses, the pipe element can have a longitudinal length that is greater than a longitudinal length of the inner tube. It is contemplated that the pipe element and the inner tube can have respective inner diameters. It is further contemplated that the pipe element can have a first opening and an opposed second opening.

Optionally, in exemplary aspects, the pipe element can comprise a drill rod, and the inner tube can comprise a core sampler, such as, for example and without limitation, a conventional inner tube assembly for retrieving core samples. However, it is contemplated that the methods described herein can be employed to remove any inner tube positioned within a concentric pipe element (outer tube). As one will appreciate, the relative dimensions of the various components of the slide hammer device can be scaled as appropriate to correspond to the dimensions of the inner tube and the pipe element. For example, it is contemplated that the respective diameters of the impact head 62, impact flange 64, and head extension 76 can each be scaled as necessary for positioning within or engagement with inner tubes and/or pipe elements.

In one aspect, the method of removing the inner tube from within the pipe element can comprise inserting the slide hammer device into the pipe element along the longitudinal axis of the pipe element. In another aspect, the method of removing the inner tube from within the pipe element can comprise advancing the slide hammer device into the pipe element along the longitudinal axis of the pipe element such that at least a portion of the impact head of the hammer assembly is received within the inner tube and at least a portion of the impact flange of the hammer assembly abuts the inner tube.

In an additional aspect, with at least a portion of the impact head of the hammer assembly positioned within the inner tube, the method of removing the inner tube from within the pipe element can further comprise advancing the guide sleeve of the slide hammer device along the longitudinal axis of the slide hammer device toward the hammer assembly such that the elongate rod of the slide hammer device is positioned in a retracted position. Optionally, it is contemplated that the retracted position can correspond to a position of the elongate rod in which the proximal end of the elongate portion of the hammer assembly engages the seat of the guide sleeve.

In a further aspect, with the elongate rod of the slide hammer device in the retracted position, the method of removing the inner tube from within the pipe element can comprise selectively applying force to the handle along the longitudinal axis of the slide hammer device. In this aspect, it is contemplated that the selective application of force to the handle can transmit a corresponding axial force to the guide sleeve and the elongate portion of the hammer assembly. It is further contemplated that the axial force transmitted to the elongate portion of the hammer assembly can also be transmitted to the inner tube through the impact flange and/or impact head.

In exemplary aspects, the step of inserting the slide hammer device into the pipe element along the longitudinal axis of the pipe element can comprise inserting the slide hammer device into the first opening of the pipe element. In these aspects, the step of, with the elongate rod of the slide hammer device in the retracted position, selectively applying force to the handle along the longitudinal axis of the pipe element comprises selectively applying force to the handle along the longitudinal axis of the pipe element such that at least a portion of the inner tube projects from the second opening of the pipe element.

Optionally, when the slide hammer device comprises a head extension as described herein, the method of removing the inner tube from within the pipe element can comprise advancing the slide hammer device into the pipe element along the longitudinal axis of the pipe element such that at least a portion of the head extension of the hammer assembly is received within the inner tube and the impact head of the hammer assembly abuts the inner tube. Thus, in an exemplary optional aspect, when the slide hammer device comprises a head extension, the method of removing the inner tube from within the pipe element can comprise advancing the slide hammer device into the pipe element along the longitudinal axis of the pipe element such that at least a portion of at least one of the impact head and the head extension of the hammer assembly is received within the inner tube and at least one of the impact flange and the impact head of the hammer assembly abuts the inner tube. In this aspect, with at least a portion of at least one of the impact head and the head extension of the hammer assembly positioned within the inner tube, the method of removing the inner tube from within the pipe element can comprise advancing the guide sleeve of the slide hammer device along the longitudinal axis of the slide hammer device toward the hammer assembly such that the elongate rod of the slide hammer device is positioned in the retracted position.

Thus, when the hammer assembly comprises a head extension as described herein, it is contemplated that a single slide hammer device can be used to remove inner tubes having a variety of inner diameters, thereby reducing the need for a separate tool for each specific inner tube size. However, it is contemplated that slide hammer devices as described herein can be specifically designed for removal of inner tubes having a set, predefined inner diameter.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A slide hammer device having a longitudinal axis, the slide hammer device comprising:
a guide sleeve having an inner surface, an outer surface, a proximal end, a distal end, and a protective flange extending radially outwardly from the outer surface of the guide sleeve and positioned between the proximal end and the distal end of the guide sleeve, the distal end defining a distal opening, the proximal end defining a proximal opening, the inner surface of the guide sleeve defining a cavity extending between the distal opening and the proximal opening, the proximal opening of the guide sleeve having a diameter;
a handle having an inner surface, an outer surface, a distal end, and a closed proximal end, the distal end defining a distal opening, the inner surface of the handle defining a cavity extending between the distal opening and the closed proximal end, the distal end of the handle being operatively engaged with the proximal end of the guide sleeve;
an elongate rod having a proximal end and a distal end, at least a portion of the elongate rod being slidably received within the cavity of the handle, the elongate rod being moveable along the longitudinal axis of the slide hammer device between an extended position and a retracted position, the proximal end of the elongate rod having a cross-sectional diameter greater than the diameter of the proximal opening of the guide sleeve, wherein, in the extended position of the elongate rod, the proximal end of the elongate rod is configured to engage the proximal end of the guide sleeve; and
a hammer assembly comprising an impact head, an impact flange, and an elongate portion, the elongate portion having a distal end and a proximal end, the proximal end of the elongate portion being securely engaged with the distal end of the elongate rod such that movement of the elongate rod along the longitudinal axis of the slide hammer device effects a corresponding movement of the elongate portion of the hammer assembly along the longitudinal axis of the slide hammer device, the impact flange being secured to and positioned between the distal end of the elongate portion and the impact head,
wherein the inner surface of the guide sleeve defines a seat for the proximal end of the elongate portion of the hammer assembly, wherein, in the retracted position of the elongate rod, the proximal end of the elongate portion of the hammer assembly is configured to engage the seat of the guide sleeve such that application of force to the handle along the longitudinal axis of the slide hammer device transmits a corresponding axial force to the guide sleeve and the elongate portion of the hammer assembly.

2. The slide hammer device of claim 1, wherein the hammer assembly comprises a head extension secured to the distal end of the impact head, the head extension extending from the distal end of the impact head along the longitudinal axis of the slide hammer device.

3. The slide hammer device of claim 2, wherein the impact head and the head extension have respective cross-sectional diameters, and wherein the cross-sectional diameter of the impact head is greater than the cross-sectional diameter of the head extension.

4. The slide hammer device of claim 1, wherein the protective flange and the impact flange have respective cross-sectional diameters, and wherein the cross-sectional diameter of the protective flange of the guide sleeve is greater than the cross-sectional diameter of the impact flange of the hammer assembly.

5. The slide hammer device of claim 1, wherein the protective flange of the guide sleeve is positioned at a selected position along the longitudinal axis of the slide hammer device, wherein the closed proximal end of the handle is spaced from the selected position by a first distance along the longitudinal axis of the slide hammer device, wherein the distal end of the guide sleeve is spaced from the selected position by a second distance along the longitudinal axis of the slide hammer device, and wherein the first distance is greater than the second distance.

6. The slide hammer device of claim 4, wherein the cross-sectional diameter of the protective flange ranges from about 100 mm to about 150 mm.

7. The slide hammer device of claim 4, wherein the cross-sectional diameter of the impact flange ranges from about 60 mm to about 100 mm.

8. The slide hammer device of claim 3, wherein the cross-sectional diameter of the impact head ranges from about 40 mm to about 80 mm.

9. The slide hammer device of claim 3, wherein the cross-sectional diameter of the head extension ranges from about 20 mm to about 60 mm.

10. The slide hammer device of claim 1, wherein the outer surface of the guide sleeve comprises a radially recessed portion positioned proximate the proximal end of the guide sleeve, at least a portion of the radially recessed portion being threaded, and wherein the inner surface of the handle comprises a threaded portion positioned proximate the distal end of the handle and configured for threaded engagement with the radially recessed portion of the outer surface of the guide sleeve.

11. The slide hammer device of claim 10, wherein the radially recessed portion of the outer surface of the guide sleeve is radially recessed relative to an adjoining portion of the guide sleeve, wherein the outer surface of the adjoining portion of the guide sleeve is substantially flush with the outer surface of the handle, and wherein the adjoining portion of the guide sleeve defines a shoulder surface configured for engagement with the distal end of the handle.

12. The slide hammer device of claim 11, wherein the threaded portion of the inner surface of the handle is radially recessed relative to adjoining portions of the inner surface of the handle.

13. A method of removing an inner tube from within a pipe element having a longitudinal axis, the pipe element and the inner tube having respective inner diameters, the method comprising:
inserting a slide hammer device into the pipe element along the longitudinal axis of the pipe element, the slide hammer device having a longitudinal axis, wherein the slide hammer device comprises:
a guide sleeve having an inner surface, an outer surface, a proximal end, a distal end, and a protective flange extending radially outwardly from the outer surface of the guide sleeve and positioned between the proximal end and the distal end of the guide sleeve, the distal end defining a distal opening, the proximal end defining a proximal opening, the inner surface of the guide sleeve defining a cavity extending between the distal opening and the proximal opening, the proximal opening of the guide sleeve having a diameter;
a handle having an inner surface, an outer surface, a distal end, and a closed proximal end, the distal end defining a distal opening, the inner surface of the handle defining a cavity extending between the distal opening and the closed proximal end, the distal end of the handle being operatively engaged with the proximal end of the guide sleeve;
an elongate rod having a proximal end and a distal end, at least a portion of the elongate rod being slidably received within the cavity of the handle, the elongate rod being moveable along the longitudinal axis of the slide hammer device between an extended position and a retracted position, the proximal end of the elongate rod having a cross-sectional diameter greater than the diameter of the proximal opening of the guide sleeve, wherein, in the extended position of the elongate rod, the proximal end of the elongate rod is configured to engage the proximal end of the guide sleeve; and
a hammer assembly comprising an impact head, an impact flange, and an elongate portion, the elongate portion having a distal end and a proximal end, the proximal end of the elongate portion being securely engaged with the distal end of the elongate rod such that movement of the elongate rod along the longitudinal axis of the slide hammer device effects a corresponding movement of the elongate portion of the hammer assembly along the longitudinal axis of the slide hammer device, the impact flange being secured to and positioned between the distal end of the elongate portion and the impact head,
wherein the inner surface of the guide sleeve defines a seat for the proximal end of the elongate portion of the hammer assembly, wherein, in the retracted position of the elongate rod, the proximal end of the elongate portion of the hammer assembly is configured to engage the seat of the guide sleeve;
advancing the slide hammer device into the pipe element along the longitudinal axis of the pipe element such that at least a portion of the impact head of the hammer assembly is received within the inner tube and the impact flange of the hammer assembly abuts the inner tube;
with at least a portion of the impact head of the hammer assembly positioned within the inner tube, advancing the guide sleeve of the slide hammer device along the longitudinal axis of the slide hammer device toward the hammer assembly such that the elongate rod of the slide hammer device is positioned in a retracted position in which the proximal end of the elongate portion of the hammer assembly engages the seat of the guide sleeve; and
with the elongate rod of the slide hammer device in a retracted position, selectively applying force to the handle along the longitudinal axis of the slide hammer device, thereby transmitting a corresponding axial force to the guide sleeve and the elongate portion of the hammer assembly.

14. The method of claim 13, wherein the pipe element comprises a drill rod.

15. The method of claim 14, wherein the inner tube comprises a core sampler.

16. The method of claim 13, wherein the pipe element defines a first opening and an opposed second opening, wherein the step of inserting the slide hammer device comprises inserting the slide hammer device into the first opening, and wherein the step of, with the elongate rod of the slide hammer device in a retracted position, selectively applying force to the handle comprises applying force to the handle along the longitudinal axis of the pipe element such that at least a portion of the inner tube projects from the second opening of the pipe element.

17. A method of removing an inner tube from within a pipe element having a longitudinal axis, the pipe element and the inner tube having respective inner diameters, the method comprising:
inserting a slide hammer device into the pipe element along the longitudinal axis of the pipe element, the slide hammer device having a longitudinal axis, wherein the slide hammer device comprises:
a guide sleeve having an inner surface, an outer surface, a proximal end, a distal end, and a protective flange extending radially outwardly from the outer surface of the guide sleeve and positioned between the proximal end and the distal end of the guide sleeve, the distal end defining a distal opening, the proximal end defining a proximal opening, the inner surface of the guide sleeve defining a cavity extending between the distal opening and the proximal opening, the proximal opening of the guide sleeve having a diameter;
a handle having an inner surface, an outer surface, a distal end, and a closed proximal end, the distal end defining a distal opening, the inner surface of the handle defining a cavity extending between the distal opening and the closed proximal end, the distal end of the handle being operatively engaged with the proximal end of the guide sleeve;
an elongate rod having a proximal end and a distal end, at least a portion of the elongate rod being slidably received within the cavity of the handle, the elongate rod being moveable along the longitudinal axis of the slide hammer device between an extended position and a retracted position, the proximal end of the elongate rod having a cross-sectional diameter greater than the diameter of the proximal opening of the guide sleeve, wherein, in the extended position of the elongate rod, the proximal end of the elongate rod is configured to engage the proximal end of the guide sleeve; and
a hammer assembly comprising an impact head, a head extension, an impact flange, and an elongate portion, the elongate portion having a distal end and a proximal end, the proximal end of the elongate portion being securely engaged with the distal end of the elongate rod such that movement of the elongate rod along the longitudinal axis of the slide hammer device effects a corresponding movement of the elongate portion of the hammer assembly along the longitudinal axis of the slide hammer device, the head extension extending from the distal end of the impact head along the longitudinal axis of the slide hammer device and having a cross-sectional area that is less than a cross-sectional diameter of the impact head, the impact flange being secured to and positioned between the distal end of the elongate portion and the impact head,
wherein the inner surface of the guide sleeve defines a seat for the proximal end of the elongate portion of the hammer assembly, wherein, in the retracted position of the elongate rod, the proximal end of the elongate portion of the hammer assembly is configured to engage the seat of the guide sleeve;
advancing the slide hammer device into the pipe element along the longitudinal axis of the pipe element such that at least a portion of at least one of the impact head and the head extension of the hammer assembly is received within the inner tube and at least one of the impact flange and the impact head of the hammer assembly abuts the inner tube;
with at least a portion of at least one of the impact head and the head extension of the hammer assembly positioned within the inner tube, advancing the guide sleeve of the slide hammer device along the longitudinal axis of the slide hammer device toward the hammer assembly such that the elongate rod of the slide hammer device is positioned in a retracted position in which the proximal end of the elongate portion of the hammer assembly engages the seat of the guide sleeve; and
with the elongate rod of the slide hammer device in a retracted position, selectively applying force to the handle along the longitudinal axis of the slide hammer device, thereby transmitting a corresponding axial force to the guide sleeve and the elongate portion of the hammer assembly.

18. The method of claim 17, wherein the pipe element comprises a drill rod.

19. The method of claim 18, wherein the inner tube comprises a core sampler.

20. The method of claim 17, wherein the pipe element defines a first opening and an opposed second opening, wherein the step of inserting the slide hammer device comprises inserting the slide hammer device into the first opening, and wherein the step of, with the elongate rod of the slide hammer device in a retracted position, selectively applying force to the handle comprises applying force to the handle along the longitudinal axis of the pipe element such that at least a portion of the inner tube projects from the second opening of the pipe element.
